(19) United States
(12) Patent Application Publication
(10) Pub. No.: US 2008/0144078 A1
(43) Pub. Date: Jun. 19, 2008

(54) System and method for easy photo print ordering from Internet server

(76) Inventors: Francis Dione V. Callo, San Jose, CA (US); Paul Jin Hwang, Burbank, CA (US); Frank Li-De Lin, Escondido, CA (US); Benjamin Lo, San Diego, CA (US); Rachel Thuy Nguyen, San Jose, CA (US); Guoxuan Zhang, San Diego, CA (US); Jianyu Roy Zheng, San Diego, CA (US)

Correspondence Address: ROGITZ & ASSOCIATES, 750 B STREET, SUITE 3120, SAN DIEGO, CA, 92101, US

(21) Appl. No.: 11/580,780

(22) Filed: Oct. 13, 2006

(51) Int. Cl. G06F 3/12

(52) U.S. Cl. 358/1.15; 358/302

(57) ABSTRACT

A user enters shipping and billing information only once to an Internet photo server. Subsequently, the user can select locally stored photos for printing or photos stored at the Internet server. In the case of locally stored photos, the Internet server automatically uploads the photos transparently to the user. In either case, the server fulfills the print order and ships the printed photos to the user.

### FIELD OF THE INVENTION

The present invention relates generally to ordering photographic prints from Internet servers.

### BACKGROUND OF THE INVENTION

Internet services have been provided wherein users can order photographic prints from Internet servers. Typically, a user connects to the server and browses available photographs, ordering those he likes for delivery.

As recognized herein, each time a user orders photographs he must enter shipping and billing information, which is repetitious. Furthermore, a user might store photos on his own personal computer but might not possess a printer, yet nonetheless wish to make prints of the photographs. As understood herein, it would be desirable to allow a user to select a locally-stored photo for printing without forcing the user to upload the photo to an Internet server just so the user could then repeat the ordering process on the server. With these critical observations in mind, the invention herein is provided.

### SUMMARY OF THE INVENTION

A method for providing photographic prints includes allowing a user of a user computer to select digitally stored photographs for printing, and then transmitting signals representing a user photograph selection to a server. The server determines whether a selected photograph represented by the signal is stored at the server, and if not, the server automatically uploads the selected photograph from the user computer to the server. Using the server, one or more prints of one or more selected photographs are generated and conveyed to the user.

In non-limiting implementations a user enters a shipping address and billing information pursuant to an initial photograph selection order, and the address and billing information are retained by the server so that the user does not enter them again for subsequent orders. The server can generate a bill and send it to the user in accordance with the billing information.

In some implementations print information is sent from the user computer and photos are printed by the server based thereon. The print information can include, e.g., size and number of prints, as well as print finish, etc.

In another aspect, a user computer includes an input device, a processor accessing a browser to communicate with the Internet, and a data store local to the user computer. Means are executable by the processor for allowing a user of the user computer to select a photo in the data store for printing by an Internet photo provider without requiring the user to upload the photo to the Internet photo provider.

In still another aspect, an internet server system includes a server processor, a server data store, and a printer. The server processor receives a selection of a photograph to be printed from a user computer over the Internet and then determines whether the photograph is stored in the server data store. If not, the server automatically uploads the photograph from the user computer to cause the printer to print the photograph.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting system that can be used to implement the invention; and

FIG. 2 is a flow chart of non-limiting logic that can be executed by the system shown in FIG. 1.

### DETAILED DESCRIPTION OF THE PREFERRED EMBODIMENT

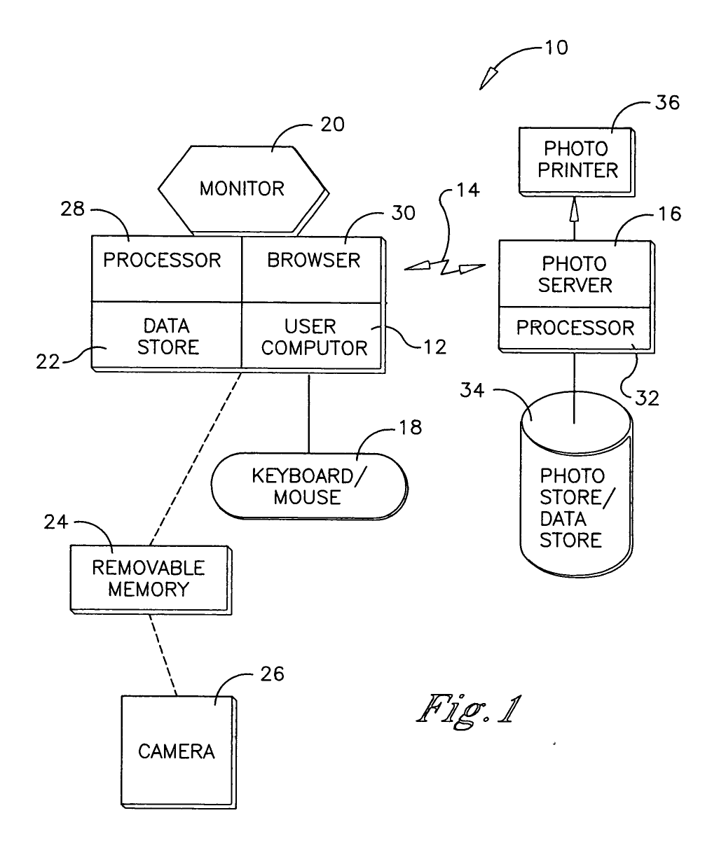

Referring initially to FIG. 1, a system is shown, generally designated 10, that includes a user computer 12, such as but not limited to a personal computer, laptop computer, notebook computer, etc. that communicates over the Internet 14 or other wide area network with a server 16. In typical non-limiting implementations the user computer 12 includes data entry devices 18 such as keyboards, mice, etc. and data output devices such as a monitor 20. However, as described further below the user computer 12 need not access a local printer.

Additionally, the user computer 12 can have a local data store 22 such as but not limited to hard disk drive, optical disk drive, alone or in combination with solid state memory, etc. Digital photographs may be stored in the local data store 22. Also, the computer 12 may be engageable with a removable memory 24 such as but not limited a Sony Memory Stick® that may also bear digital photographs taken by a camera 26 with which the removable memory 24 can be engaged. A user computer processor 28 can execute logic stored in local memory to execute various steps described further below by communicating with the server 16 using a browser 30.

Completing the description of FIG. 1, the server 16 includes a server processor 32 that can access a server store 34, and the server store 34 can contain photograph files and other data, including user shipping data and billing information. Also, the server 16 can print hard copy prints of digital photographs using a server printer 36, for shipping of the prints to a user of the user computer 12.

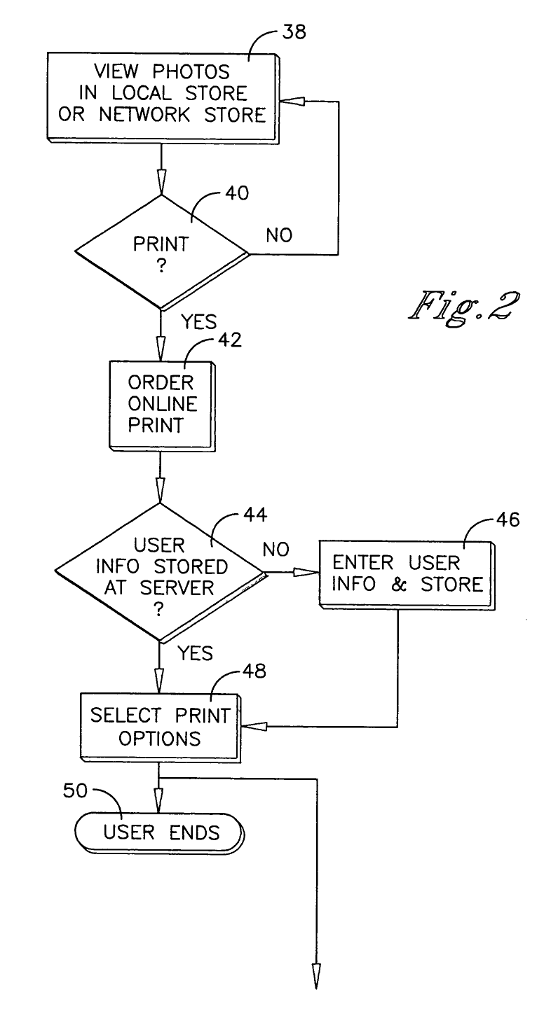

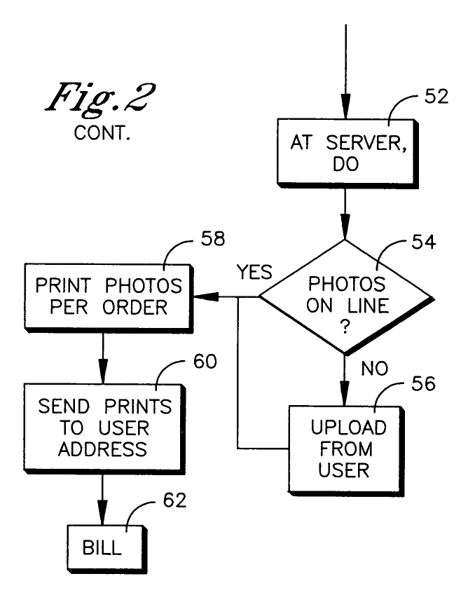

Now turning to FIG. 2, the present logic can be seen, it being understood that some of the logic is executed by the user computer processor 28, some by the server processor 32, and some by either or both of the processors 28, 32.

Commencing at block 38, a user of the user computer 12 can view photographs stored locally (e.g., on the data store 22 or removable memory 24) or stored remotely, e.g., in the server photo store 34. To view remotely stored photos the user computer 12 communicates with the server 16 in accordance with principles known in the art. The user may sign in to the server 16 with a user name and password if desired.

Decision diamond 40 simply indicates that the user can indicate, by means of, e.g., the input device 18, a desire to print one or more photos being viewed. In one non-limiting implementation the user need only position the screen cursor over a photo and click the mouse to indicate “print”, it being understood that other methods for designating a photo to be printed can be used. This causes an online print order to be conveyed to the server 16 at block 42.

At decision diamond 44, the server processor 32 determines whether the particular user is associated with user shipping and billing information already resident at the server store 34. If not, the user is prompted to enter this information at block 46, and the information is then stored at the server 16. The information can include shipping address, billing information, etc. In this way, the user need enter this information only once, such that for subsequent photo ordering sessions (which may occur after logout and subsequent login) the user need not engage in repetitious data entry. It is to be understood that the user computer processor 28 alternatively may undertake the logic at decision diamond 44.

Proceeding to block 48, the user can select print options, e.g., size, number, color, finish, etc. Once the user has selected the appropriate print options the user's logic ends at state 50.

The server 16, however, continues processing automatically and transparently to the user by entering a do loop at block 52, in which the server determines, at decision diamond 54, whether the photos selected by the user for printing are online, i.e., are available in the server store 34. If not, the server 16 automatically uploads the photos from the user computer 12 (e.g., from the user data store 22 or removable memory 24) to the server store 34 at block 56. Once the server 16 has access to the selected photos, the photos are printed by the server 16 using the photo printer 36 at block 58 in accordance with the print options selected by the user at block 48. The prints are sent to the user's shipping address at block 60 using, e.g., regular mail, and the user is billed for the prints at block 62 using the user billing information.

It may now be appreciated that with the present invention, users can order prints of local/network digital photos through their favorite online printing service. The user can browse through photos stored on his local computer or on the network, and can then select any pictures that he would like printed. After photo selection, the server 16 checks to see if the selected photos have already been uploaded to the respective online printing service and if they haven't been uploaded, the photos are transferred, and then the order for these prints would then be put into the online printing service. Consequently, the process for purchasing photo prints through online photo print providers is simplified.

While the particular SYSTEM AND METHOD FOR EASY PHOTO PRINT ORDERING FROM INTERNET SERVER is herein shown and described in detail, it is to be understood that the subject matter which is encompassed by the present invention is limited only by the claims.

What is claimed is:

1. A method for providing photographic prints, comprising:
allowing a user of a user computer to select digitally stored photographs for printing;
transmitting signals representing a user photograph selection to a server;
determining, at the server, whether a selected photograph represented by the signal is stored at the server, and if not, automatically uploading the selected photograph from the user computer to the server;
using the server, generating at least one print of at least one selected photograph; and
conveying the print to the user.

2. The method of claim 1, wherein a user enters a shipping address pursuant to an initial photograph selection order, the address being retained by the server so that the user does not enter the shipping address for subsequent orders.

3. The method of claim 2, wherein a user enters billing information pursuant to an initial photograph selection order, the billing information being retained by the server so that the user does not enter the billing information for subsequent orders.

4. The method of claim 3, comprising generating a bill and sending it to the user in accordance with the billing information.

5. The method of claim 1, comprising receiving print information from the user computer and undertaking the generating act based at least partially thereon.

6. The method of claim 5, wherein the print information includes size and number of prints.

7. A user computer, comprising:
at least one input device;
at least one processor accessing a browser to communicate with the Internet;
at least one data store local to the user computer; and
means executable by the processor for allowing a user of the user computer to select, using the input device, at least one photo in the data store for printing by an Internet photo provider without requiring the user to upload the photo to the Internet photo provider.

8. The user computer of claim 7, wherein the photo is automatically uploaded from the data store to the Internet photo provider without requiring user interaction.

9. The user computer of claim 8, comprising means executable by the processor for allowing a user to enter a shipping address pursuant to an initial photograph selection order, the address being retained by the Internet photo provider so that the user does not enter the shipping address for subsequent orders.

10. The computer of claim 9, comprising means executable by the processor for allowing a user to enter billing information pursuant to an initial photograph selection order, the billing information being retained by the Internet photo provider so that the user does not enter the billing information for subsequent orders.

11. The computer of claim 10, comprising means for receiving print information from the user.

12. The computer of claim 11, wherein the print information includes size and number of prints.

13. An internet server system, comprising:
at least one processor;
at least one server data store; and
at least one printer;
wherein the processor receives at least one selection of a photograph to be printed from at least one user computer over the Internet, the processor determining whether the photograph is stored in the server data store and if not, automatically uploading the photograph from the user computer to cause the printer to print the photograph.

14. The system of claim 13, wherein the server system causes printed photographs to be conveyed to users' shipping addresses.

15. The system of claim 13, wherein a user enters a shipping address pursuant to an initial photograph selection order, the address being retained by the processor so that the user does not enter the shipping address for subsequent orders.

16. The system of claim 13, wherein a user enters billing information pursuant to an initial photograph selection order, the billing information being retained by the processor so that the user does not enter the billing information for subsequent orders.

17. The system of claim 16, wherein the processor generates a bill and sending it to the user in accordance with the billing information.

18. The system of claim 13, wherein the processor receives print information from the user computer and generates prints based at least partially thereon.

19. The system of claim 18, wherein the print information includes size and number of prints.
